(19) United States
(12) Patent Application Publication
(10) Pub. No.: US 2018/0158012 A1
(43) Pub. Date: Jun. 7, 2018

(54) SYSTEMS AND METHODS FOR COMPETENCY-BASED TASK MANAGEMENT

(71) Applicant: Christopher Thibodeaux, Wayzata, MN (US)

(72) Inventor: Christopher Thibodeaux, Wayzata, MN (US)

(21) Appl. No.: 15/829,181

(22) Filed: Dec. 1, 2017

Related U.S. Application Data
(60) Provisional application No. 62/428,865, filed on Dec. 1, 2016.

(51) Int. Cl. G06Q 10/06

(52) U.S. Cl. CPC G06Q 10/063112; G06Q 10/0637; G06Q 10/06398; G06Q 10/063114

(57) ABSTRACT

A competency-based task management system. Embodiments comprise a user input mechanism for receiving a goal, identification of one or more competencies, an identification of one or more decision makers, and a status of each of one or more tasks. A task generation engine can generate the one or more tasks by creating a task representing a demonstration each of the one or more competencies to each of the one or more decision makers and storing the task and the status of the task in an assessment table in a memory of the server module. An evaluation engine can be configured to determine a progress metric based on the status of each of the tasks in the assessment table. An output mechanism can be configured to dynamically display the progress metric and each of the one or more tasks in juxtaposed arrangement with a current status of the task.

### CROSS-REFERENCE TO RELATED APPLICATIONS

This application claims the benefit of U.S. Provisional Patent Application No. 62/428,865, filed Dec. 1, 2016, the disclose of which is incorporated by reference herein.

### TECHNICAL FIELD

Embodiments of the present disclosure generally relate to systems and methods for automated task generation and management, including methodologies for the computer-based implementation thereof.

### BACKGROUND

In order to meet goals, especially career goals that require influencing one or more decision makers, it is often necessary to gain or demonstrate one or more competencies. In many situations, however, the necessary competencies for attaining a goal may not be readily ascertainable, or the decisions makers for a position are unknown. Even where the necessary information is available, users can be frustrated in their attempts to achieve their goals when actions taken are not optimized to produce results that will influence the appropriate decisions makers.

Many task-tracking, project planning, and to-do list management utilities exist. Such tools allow users to plan future tasks, taking into account dependencies and estimates of time and/or cost. Convention task management systems however, can frustrate the attempts of users to effectively plan to meet goals that require influencing one or more decision makers. Users who attempt to create effective plans for goal achievement can be frustrated by the lack of visibility as to which competencies are needed, which decision makers have yet to be influenced, and what actions should be taken in order to effectively influence decision makers.

### SUMMARY

Embodiments of the present disclosure meet the need for systems and methods for competency-based task management. A user interface enables identification of key competencies and decision makers and existing correlations between each. An evaluation engine calculates at least one assessment score. In embodiments, generated reports can include one or more lists of competencies that have yet to be demonstrated to decision makers. In embodiments, the user interface can enable the creation of tasks chosen to address each gap.

In an embodiment, a competency-based task management system comprises a user input mechanism in a client module configured to receive an identification of one or more competencies related to a goal, an identification of one or more decision makers related to the goal, and a status of each of one or more tasks. A task generation engine in a server module, in data communication with the client module, can be configured to generate the one or more tasks by creating a task representing a demonstration each of the one or more competencies to each of the one or more decision makers, assigning an incomplete status to the task, and storing the task and the status of the task in an assessment table in a memory of the server module. An evaluation engine in the server module can be configured to determine a progress metric based on the status of each of the tasks in the assessment table in response to a user input. An output mechanism in the client module can be configured to dynamically display the progress metric and each of the one or more tasks in juxtaposed arrangement with a current status of the task.

In an embodiment, the client module and the server module can each reside on a single computing system. In an embodiments, the single computing system is selected from the group consisting of: a desktop computer, a laptop computer, a mobile phone, and a tablet. In embodiments, the client module can comprise a mobile application, or a web application.

In an embodiment, the system can further comprise a knowledge repository in the memory of the server module. The knowledge repository can be configured to store a plurality of previously identified competencies for each of a plurality of previously identified goals. In embodiments, the output mechanism can be further configured to display one or more suggested competencies based on the plurality of previously identified competencies in response to the user input including an identification of a previously identified goal.

In an embodiment, the knowledge repository can be configured to store one or more actions related to each of a plurality of competencies. The task generation engine can be further configured to generate one or more additional tasks by creating an additional task related to at least one of the one or more actions in the knowledge repository, and storing the additional task and the status of the additional task in the memory of the server module.

In embodiments of the present disclosure, competency-based task management method can comprise: identifying one or more competencies related to a goal, identifying of one or more decision makers related to the goal, generating a plurality of tasks each task representing a demonstration of each of the one or more competencies to each of the one or more decision makers and storing the plurality of tasks in a memory of a computer system. In embodiments, a user input related to a status of at least one of the one or more tasks can be received and storing the status in the memory of the computer system. In embodiments a progress metric can be generated based on the status of each of the one or more tasks. In embodiments, a dynamic output can be provided. The dynamic output can include the progress metric and each of the one or more tasks in juxtaposed arrangement with a current status of the task. The output can updated based on a received user input related to the goal, at least one of the one or competencies, at least one of the one or more decision makers, or the status of at least one of the one or more tasks. In embodiments, the output is provided, and the user input is received, on a client module in data communication with the computer system.

### BRIEF DESCRIPTION OF THE DRAWINGS

Subject matter hereof may be more completely understood in consideration of the following detailed description of various embodiments in connection with the accompanying figures.

FIG. 1 is a block diagram depicting a competency-based task management system, according to an embodiment.

FIG. 2A is a diagram depicting a conceptual view of an assessment table, according to an embodiment.

FIG. 2B is a diagram depicting an alternative conceptual view of the assessment table of FIG. 2A, according to an embodiment.

FIG. 3 is a flowchart depicting a method for competency assessment, according to an embodiment.

FIG. 4A depicts a gap list, according to an embodiment.

FIG. 4B depicts an action item list, according to an embodiment.

FIGS. 5A-G depict a series of user interface screens for a mobile application embodiment of a competency-based task management system for entry of data to be assessed, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

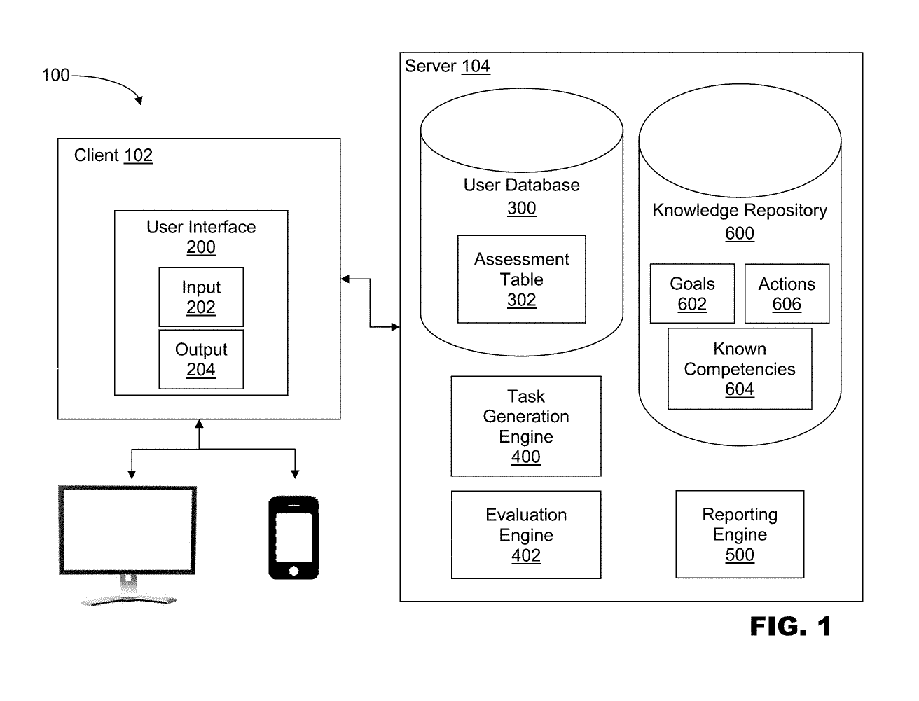

FIG. 1 is a block diagram depicting a competency-based task management system 100 according to an embodiment. System 100 can comprise client module 102 and server module 104. client module 102 and server module 104 can comprise software modules. In embodiments, client module 102 and server module 104 can reside on separate and distinct computing systems, or reside within the same computing system, other any other configuration that enables data communication between client module 102 and server module 104 can be used by embodiments.

Client module 102 can comprise user interface 200. User interface 200 can comprise input mechanism 202 and output mechanism 204. In embodiments, user interface 200 can comprise text-based, graphical user interface (GUI), three-dimensional (3D) or other interface components. In embodiments, input mechanism 202 can comprise a keyboard, mouse, touchpad, joystick, or any device capable of receiving user input known in the art. In embodiments, output mechanism 204 can comprise a display screen, projector, audio output, or any other dynamic output mechanism known in the art. In embodiments, user interface 200 can comprise a programmatic interface such as an application programming interface (API), enabling programmatic interaction with system 100 for data entry, data retrieval, configuration, or any other user task. Client module 102 can present user interface 200 as a computer application, mobile application, web application, or in another presentation format.

Server module 104 can comprise user database 300. User database 300 can be configured to store one or more assessment tables 302 associated each of one or more users. Assessment tables 302 can be generated by task generation engine 400. Evaluation engine 402 can be configured to determine a progress metric or score based on the data in assessment tables 302. Reporting engine 500 can generate one or more report types based on data stored in user database 300. Reporting engine 500 can provide reports to the user via user interface 200. In embodiments, knowledge repository 600 can store data related to previously identified goals 602, associated competencies 604 known to be associated with them and actions 606 that can be taken to demonstrate or acquire the associated competencies 604. For example, actions 606 for a “project management” competency can include “requesting an assignment to lead a small team on a project,” “providing a status update to a decision maker regarding a small team project,” or “taking an online course in the use of a project management tool.” In embodiments, each data storage component of system 100 (such as user database 300 and knowledge repository 600) can comprise one or more relational databases with tabular structure, or NoSQL or other non-relational databases with key-value, grid, or other structures. In embodiments, system 100 can comprise one or more spreadsheet or database files and associated application software.

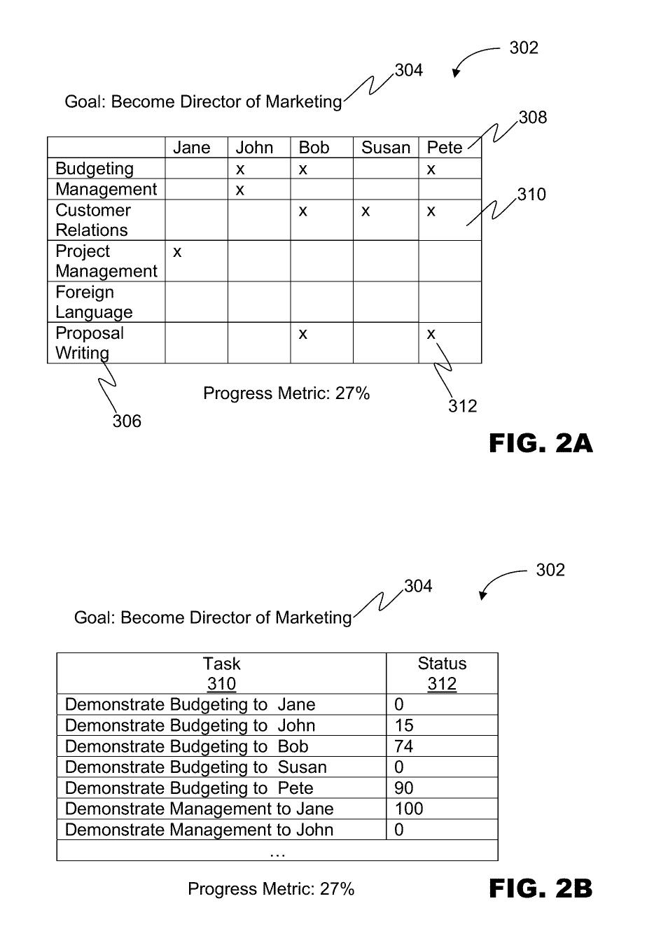

FIG. 2A is a diagram depicting a conceptual view of an assessment table 302 according to an embodiment. Assessment table 302 can be stored in user database 300, associated with a specific client user in embodiments. In embodiments, assessment table 302 can be associated with multiple or all users. Assessment table 302 can comprise a goal 304, one or more competencies 306, and one or more decision makers 308. Assessment table 302 can further comprise one or more tasks 310, which can be generated based on correlations between a competency 306 and a decision maker 308. Each task 310 can have a status 312. In embodiments, each status 312 can comprise a simple, Boolean, yes/no or true/false value. In embodiments, status 312 can include numerical or scaled values representative of the data related to the task, such a percent complete. Each goal 304 can have an associated progress metric 314. Progress metric 314 can be provided by the user, or calculated by evaluation engine 400, as described below.

FIG. 2B is a diagram depicting an alternative view of assessment table 302. FIG. 2B is arranged as a list of tasks 310. Each task 310 has an extended description or name generated using a competency 306 and a decision maker 308. The status 312 of each task is also depicted as a numerical value between 0 and 100. Those of ordinary skill in the art will appreciate that alternative storage and display formats for assessment table 302 are possible.

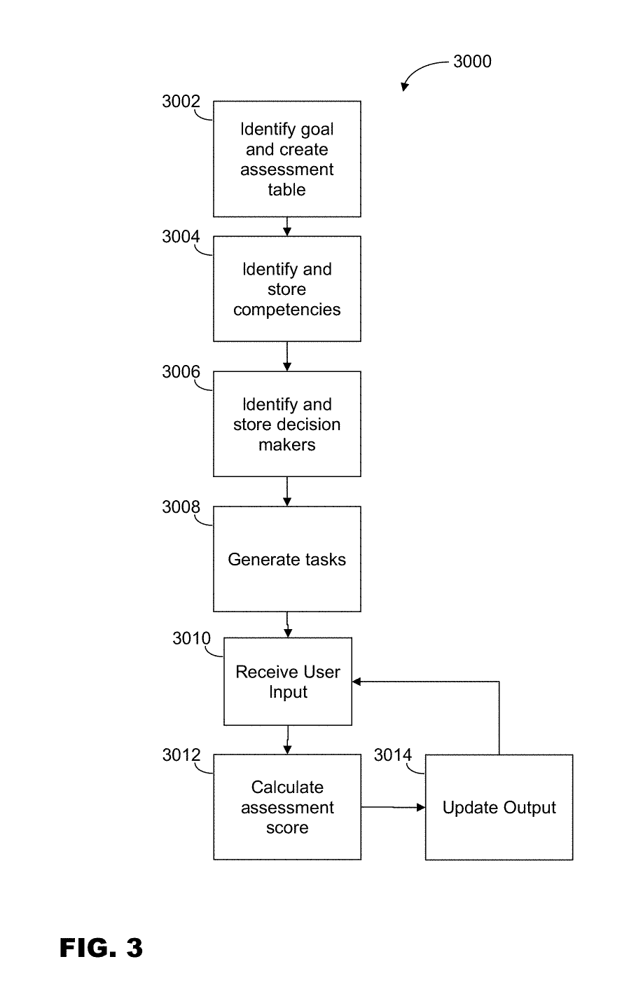

FIG. 3 is a flowchart depicting a method 3000 for competency-based task management according in an embodiment. At 3002, a goal 304 is identified and a new assessment table 302 is created within user database 300. At 3004, one or more competencies 306 associated with the goal 304 are identified, and added to the assessment table 302 within user database 300. In embodiments, users may enter the associated competencies 306. In embodiments, one or more known competencies 604 can be populated from knowledge repository 600. In embodiments, user interface 200 may enable users to edit competencies populated from knowledge repository 600. In embodiments, competencies entered by a user can be stored in knowledge repository 600 for later use.

At 3006, one or more decision makers 308 associated with the goal 304 are identified and added to the assessment table 302. At 3008, tasks 310 for generating each competency 306 to each decision maker 308. At 3010, user input can be received that can trigger evaluation engine 400 to calculate progress metric 314. Progress metric 314 can be an assessment score, percentage, scalar number, letter grade (for example, A+, B, C . . . ), color (for example red, yellow, or green), or other form of metric. In embodiments, progress metric 314 can be calculated based on the number of completed tasks 310 compared to the total number of tasks. In embodiments, progress metric 314 can be calculated using numerical or scaled values for task status 312, or weights associated with one or more competencies 306 and decision makers 308.

At 3014, reporting engine 500 can generate one or more reports related to one or more assessment tables 302, and the output provided to output mechanism 204. In embodiments, reports can include progress metric 314, visualizations of assessment table 302, and/or gap lists 316. In embodiments, reports can be stored in user database 300. In embodiments, reports can be displayed to a user via user interface 200.

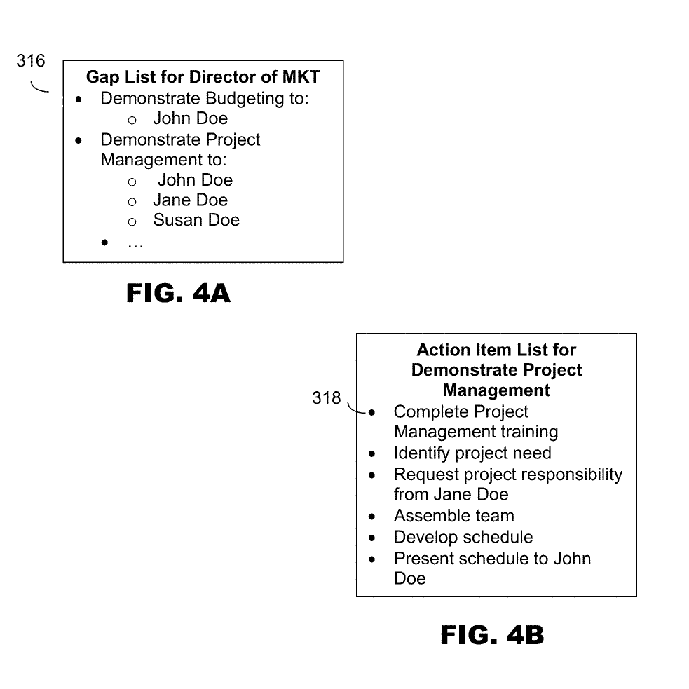

FIG. 4A depicts an example of a partial gap list 316 generated by reporting engine 500 based on the assessment table 302 of FIG. 2A. Gap list 316 comprises one or more competency-decision maker pairs. In embodiments, gap list 316 can include pairs for which no status 312 is known. In embodiments, gap list 316 can include tasks for which status 312 does not meet one or more configurable criteria. In embodiments, gap list 316 can be grouped by competency as depicted in FIG. 4A, while in other embodiments, gap list 316 can be grouped by decision maker. In embodiments, gap lists 316 can be provided in one or more formats configured to be incorporated into scheduling software of types known in the art such as Microsoft Outlook, or SimpleNote.

In embodiments, user interface 200 can present one or more interfaces enabling users to create, modify, delete, or otherwise interact with one or more action items 318 based on gap list 316. FIG. 4B depicts a list of action items 318 related to the gap list 316 of FIG. 4A. In embodiments, action items 318 can be stored in user database 300 as additional tasks 310. In embodiments, action items 318 can be associated with tasks 310, such that an action item 318 associated with a competency 306 that includes a decision maker 308 can be highlighted in one or more reports generated by reporting engine 500. In embodiments, reporting engine 500 can identify action items 318 associated with multiple assessment tables 302. In embodiments, action items 318 can be ranked, sorted, or displayed in order of the number of assessment tables 302 impacted, enabling client to focus on tasks that may improve their assessment scores for multiple target positions. In embodiments, user interface 200 can enable users to mark one or more action items 318 with status flags identifying commencement and/or completion. In embodiments, action items 318 can be provided in one or more formats configured to be incorporated into scheduling software of types known in the art such as Microsoft Outlook, or SimpleNote. In embodiments, one or more sample action items 606 associated with known competencies 604 can be stored in knowledge repository 600 of system 100. A list of action items 318 can therefore be pre-populated based on gap list 316 and knowledge repository 600.

In embodiments, user interface 200 can enable users to provide feedback on previously identified goals 602, known competencies 604 or sample action items 606. Such feedback data can be stored in knowledge repository 600. For example, user interface 200 can enable a user to indicate that a known competency 604 is not relevant to their specific goal, or that a sample action item 606 was very influential in enabling them to reach the goal. The feedback stored in knowledge repository 600 can be used (alone, or with data specific to the current user) to select goals, competencies, or action items to suggest.

In embodiments, system 100 can comprise a user management engine (not shown). User management engine can be configured to maintain data regarding users of system 100 include user names, authentication information, and user types. In embodiments, user types can include client users, training users, and administrative users. In embodiments, system 100 can enable different user types to access different information. For example, in embodiments each data item stored in user database 300 can be accessible only to trainer users, or to a client user associated with the data item. In embodiments, trainer users can have access to edit assessment tables 302, gap lists 316, action items 318, tasks 310, or data items in knowledge repository 600, while client users are permitted to edit only assessment tables 302 and action items 318. In embodiments, administrative users can have full access to all components of system 100.

In embodiments, system 100 can enable client and trainer users to interact to develop a plan for addressing competency gaps. For example, a client user may access system 100 and execute method 3000 to generate an assessment table to be stored in user database 300. A trainer user may then create action items 318 to be communicated to the client user. The client user may then interact with each task, for example to mark each task complete in turn. In embodiments, reporting engine 500 can generate one or more reports based on historical data stored within user database 300, enabling reporting of trends over time.

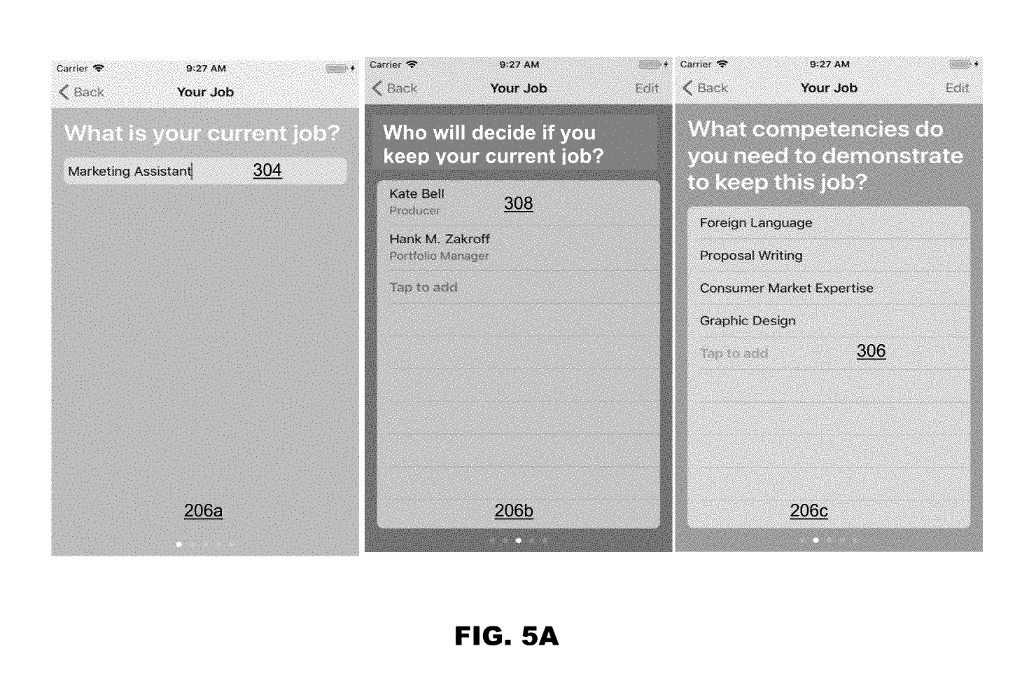

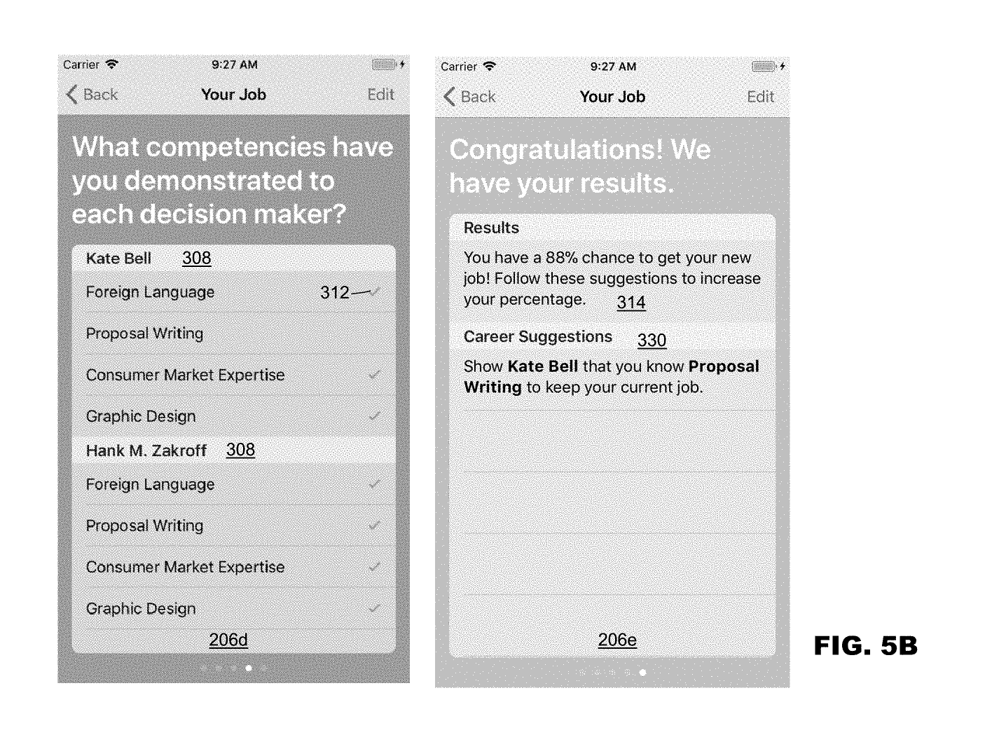

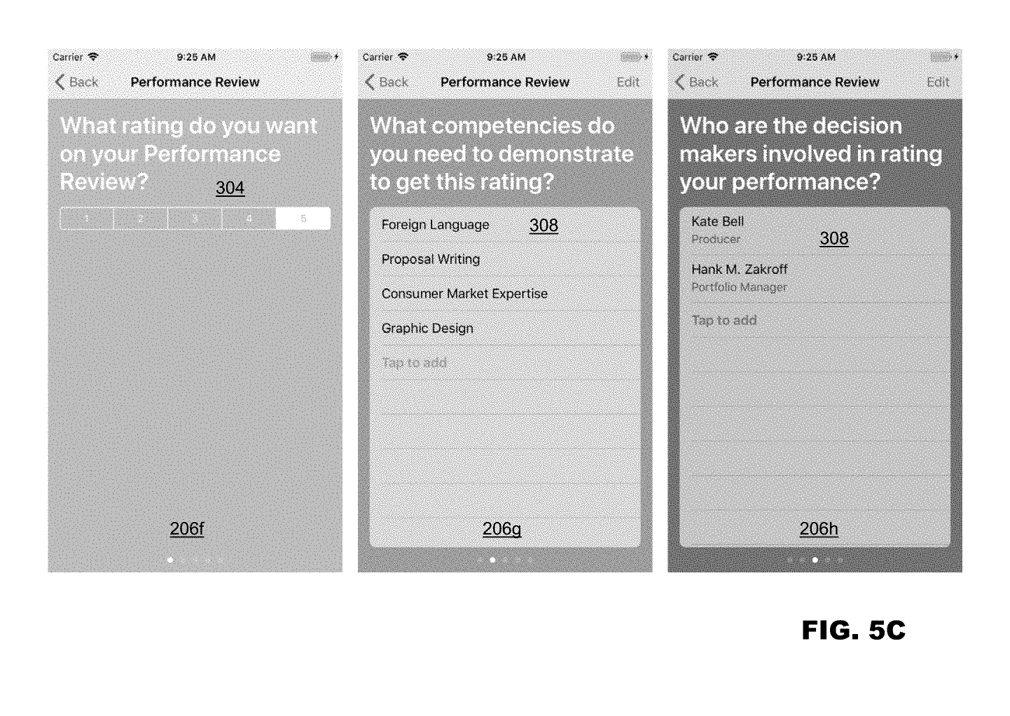

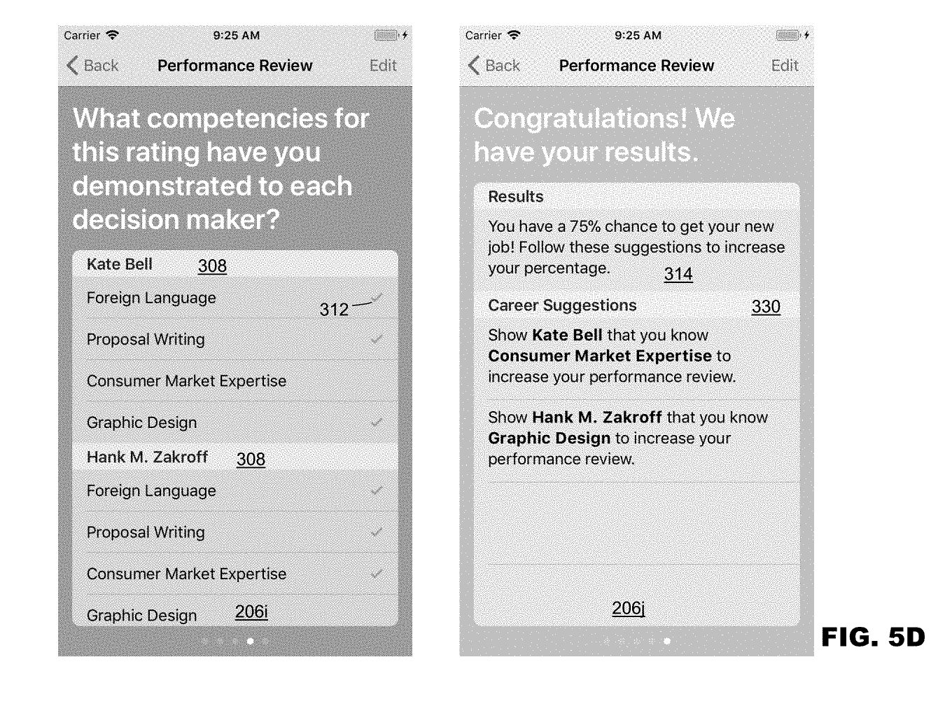

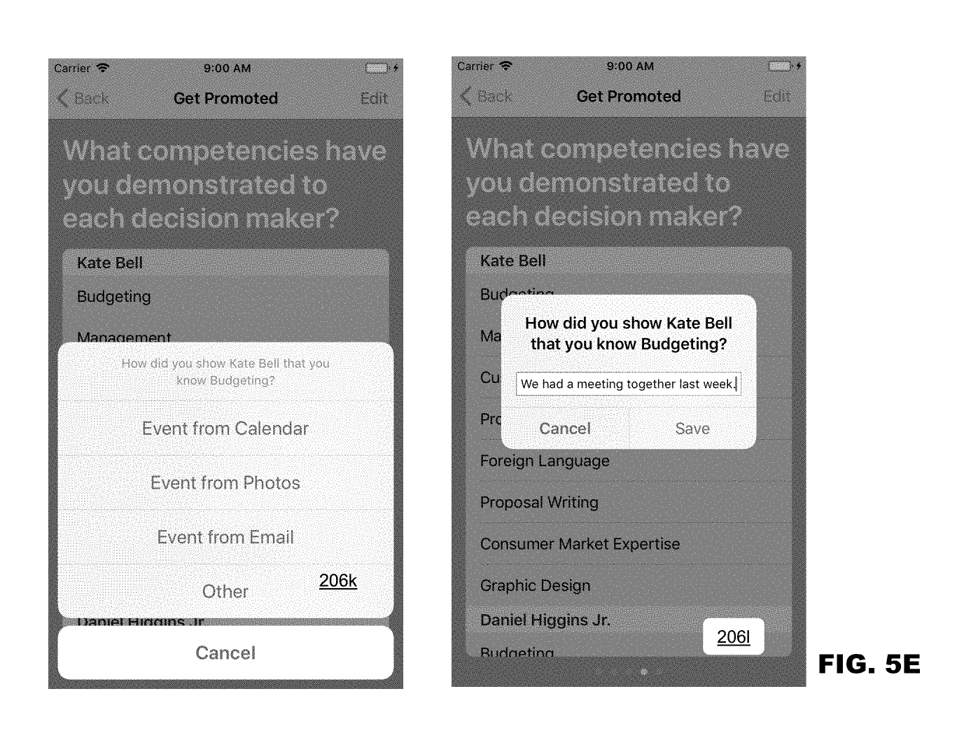

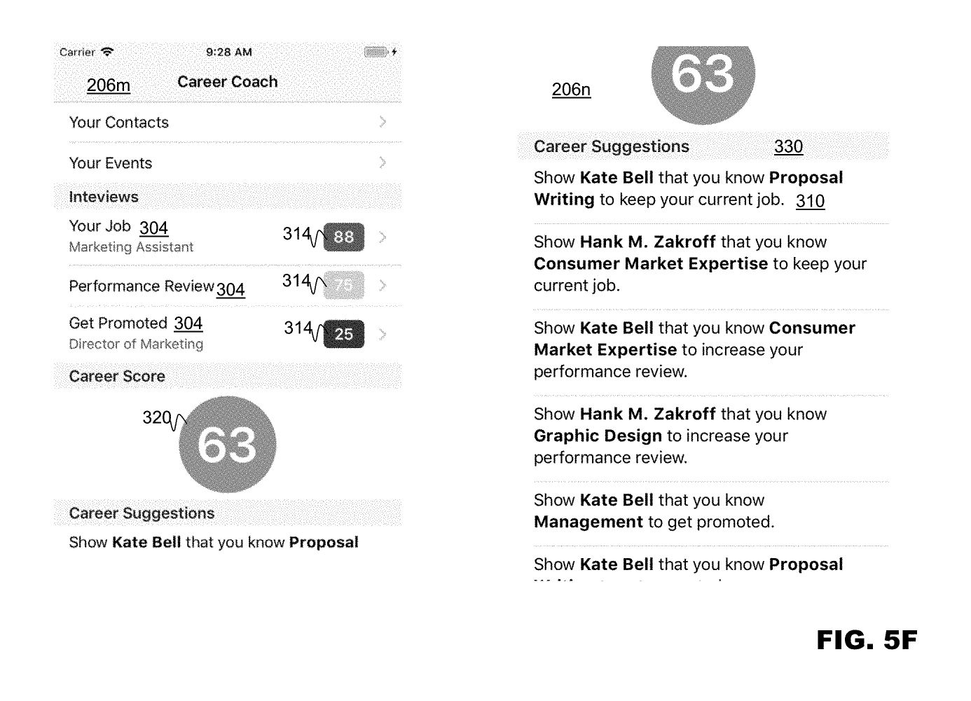

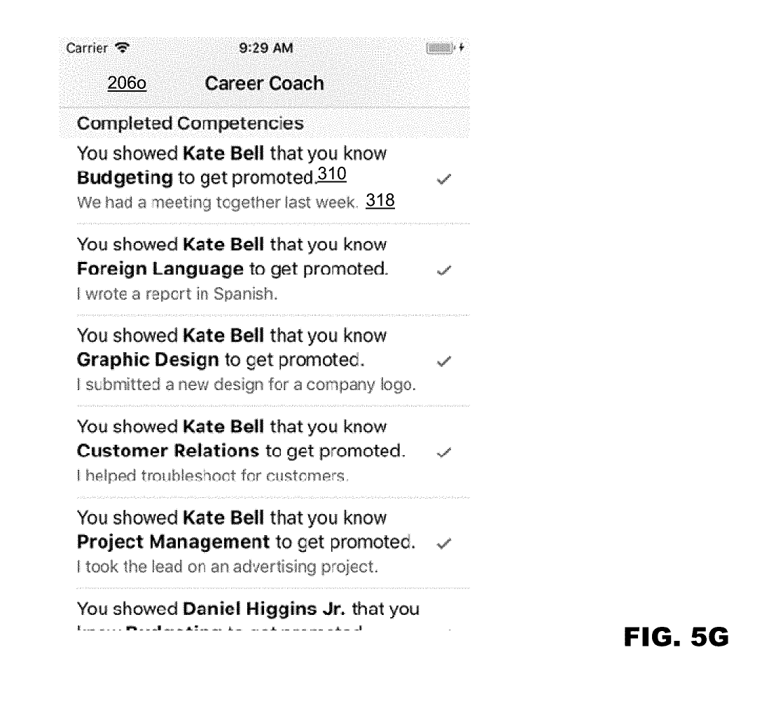

FIGS. 5A-5E depict a series of application screens, as may be presented by a mobile application embodiment of the present disclosure. FIGS. 5A and 5B depict a series of screens 206a-e that can be presented by user interface 200 to receive user input and present output related to a goal of keeping the user's current job. Screens 206a-c enable the user to identify a goal 304, decision makers 308 for the goal 304, and competencies 306 for goal 304, respectively.

In FIG. 5B, screen 206d presents a view of assessment table 302, where competencies 306 are grouped by decision maker 308. Screen 206d can further enable the user to mark completed tasks with check marks, in order to set the status 312. The juxtaposition of the tasks 310 and action items 318 with the status 312 of those items provides an efficient and user-friendly interface that can be used both to provide information regarding status, and dynamic updates. Screen 206e presents progress metric 314, and gap list 316. In embodiments, input mechanism 202 can enable the user to select an task 310 on gap list 316 in order to view suggested action items that can be used to complete it.

FIGS. 5C and 5D depict a series of screens 206f-j that can be presented by user interface 200 to receive user input and present output related to a goal of achieving a target rating on a performance review. Screens 206f-h enable the user to identify a goal 304, decision makers 308 for the goal 304, and competencies 306 for goal 304, respectively. In FIG. 5D, screen 206i presents a view of assessment table 302, where competencies 306 are grouped by decision maker 308. Screen 206i can further enable the user to mark completed tasks with check marks, in order to set the status 312. Screen 206j presents progress metric 314, and gap list 316. In embodiments, input mechanism 202 can enable the user to select an task 310 on gap list 316 in order to view suggested action items that can be used to complete it.

FIG. 5E is depicts screens 206k and 206l that can be presented by user interface 200 to enable the user to provide additional information regarding tasks 310 and action items 318. Screen 206k comprises user interface controls enabling the user to import events or other data from other sources on the mobile device, such as a Calendar, Photos, or Email. Screen 206l comprises a text input control.

FIGS. 5F-5G depict screens 206m-o that can be presented by user interface 200 to provide the user with an overall summary of their current goals. Home screen 206m can comprise a list of goals 304, and the progress metric 314 associated with each. In embodiments, the performance metric 314 can be color coded. Screen 206m can further include an overall summary score 320, which can, in embodiments, be calculated based on the progress metrics 314 of each goal 304. Screen 206n can be a continuation of home screen 206m (or a separate screen). Screen 206n can present an aggregated gap list 316 including tasks 310 associated with multiple goals 304. Screen 206o can present completed tasks 310 including details of the action items 318 that were completed in order to satisfy each task 310. Screens 206m-o can be updated dynamically based on user input provided through other screens of the application, or through other client modules that are in data communication with the server module holding the user's data.

The systems and methods of the present disclosure enable a number of beneficial use cases. In one example, system 100 can be provided as part of a career or life coaching program. A trainer user can access user interface 200 via a client module and create an assessment table 302, gap list 316 and or action items 318 based on offline conversations with a trainee. The trainer can then present trainee with one or more performance metrics 314 as part of a benchmarking exercise. Alternatively, the trainee can provide data input regarding goals 304, competencies 306, and decision makers 308 through user interface 200. The trainer could then, for example, suggest specific tasks 310 and action items 318 for the trainee to perform.

In another example, the system 100 can be used for self-guided coaching. A trainee user can identify a goal 304, and be presented with suggested competencies 306, tasks 310, and action items 318 based on the data stored in knowledge repository 600. Because, in embodiments, knowledge repository 600 can include data from all users of the system, the knowledge repository 600 can provide “crowd-sourced” advice, based on decisions made by previous users. Many other use cases are enabled by system 100.

In one embodiment, the system 100 and/or its components or subsystems can include computing devices, microprocessors, modules and other computer or computing devices, which can be any programmable device that accepts digital data as input, is configured to process the input according to instructions or algorithms, and provides results as outputs. In one embodiment, computing and other such devices discussed herein can be, comprise, contain, or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In one embodiment, volatile memory can include random access memory (RAM), dynamic random access memory (DRAM), or static random access memory (SRAM), for example. In one embodiment, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the disclosure.

In one embodiment, the system or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application-specific integrated circuit (ASIC) or field-10 programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that embodiments may comprise fewer features than illustrated in any individual embodiment described above. The embodiments described herein are not meant to be an exhaustive presentation of the ways in which the various features may be combined. Accordingly, the embodiments are not mutually exclusive combinations of features; rather, embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Moreover, reference in the specification to “one embodiment,” “an embodiment,” or “some embodiments” means that a particular feature, structure, or characteristic, described in connection with the embodiment, is included in at least one embodiment of the teaching. The appearances of the phrase “in one embodiment” in various places in the specification are not necessarily all referring to the same embodiment.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of Section 112, sixth paragraph of 35 U.S.C. are not to be invoked unless the specific terms “means for” or “step for” are recited in a claim.

What is claimed is:

1. A competency-based task management system comprising:
a user input mechanism in a client module configured to receive an identification of one or more competencies related to a goal, an identification of one or more decision makers related to the goal, and a status of each of one or more tasks;
a task generation engine in a server module, in data communication with the client module, and configured to generate the one or more tasks by—
creating a task representing a demonstration each of the one or more competencies to each of the one or more decision makers, assigning an incomplete status to the task, and storing the task and the status of the task in an assessment table in a memory of the server module;
an evaluation engine in the server module configured to determine a progress metric based on the status of each of the tasks in the assessment table in response to a user input;
an output mechanism in the client module configured to dynamically display the progress metric and each of the one or more tasks in juxtaposed arrangement with a current status of the task.

2. The system of claim 1, wherein the client module and the server module each reside on a single computing system.

3. The system of claim 2, wherein the single computing system is selected from the group consisting of: a desktop computer, a laptop computer, a mobile phone, and a tablet.

4. The system of claim 1, wherein the client module comprises a mobile application.

5. The system of claim 1, wherein the client module comprises a web application.

6. The system of claim 1, further comprising a knowledge repository in the memory of the server module configured to store a plurality of previously identified competencies for each of a plurality of previously identified goals, and wherein the output mechanism is further configured to display one or more suggested competencies based on the plurality of previously identified competencies in response to the user input including an identification of a previously identified goal.

7. The system of claim 1, further comprising:
a knowledge repository configured to store one or more actions related to each of a plurality of competencies in the memory of the server module; and
wherein the task generation engine is further configured to generate one or more additional tasks by creating an additional task related to at least one of the one or more actions in the knowledge repository, and storing the additional task and the status of the additional task in the memory of the server module.

8. A competency-based task management method comprising:
identifying one or more competencies related to a goal;
identifying of one or more decision makers related to the goal;
generating a plurality of tasks each task representing a demonstration of each of the one or more competencies to each of the one or more decision makers and storing the plurality of tasks in a memory of a computer system;
receiving a user input related to a status of at least one of the one or more tasks and storing the status in the memory of the computer system;
generating a progress metric based on the status of each of the one or more tasks;
providing a dynamic output including the progress metric and each of the one or more tasks in juxtaposed arrangement with a current status of the task; and
updating the output based on a received user input related to the goal, at least one of the one or competencies, at least one of the one or more decision makers, or the status of at least one of the one or more tasks.

9. The method of claim 8, wherein the output is provided, and the user input is received, on a client module in data communication with the computer system.

10. The method of claim 8, further comprising:
storing a plurality of previously identified competencies for each of a plurality of previously identified goals in the memory of the computer system;
and wherein the dynamic output further comprises a display of one or more suggested competencies based on the plurality of previously identified competencies in response to the user input including an identification of a previously identified goal.

11. The method of claim 8, further comprising:
storing one or more actions related to each of a plurality of competencies in a knowledge repository in the memory of the computer system; and
generating one or more additional tasks related to a competency by creating an additional task based on at least one of the one or more actions related to the competency.
